(19) United States
(12) Patent Application Publication
(10) Pub. No.: US 2007/0162877 A1
(43) Pub. Date: Jul. 12, 2007

(54) INTERNET-BASED METHOD FOR ENABLING USERS TO DETERMINE WHAT IS MISSING FROM THEIR WEBSITE

(76) Inventor: Sharon Drew MORGEN, Austin, TX (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/539,262

(22) Filed: Oct. 6, 2006

Related U.S. Application Data
(63) Continuation of application No. 09/909,411, filed on Jul. 19, 2001, now abandoned.
(60) Provisional application No. 60/219,153, filed on Jul. 19, 2000.

(51) Int. Cl. G06F 3/048; G06F 17/00; G06F 7/00

(52) U.S. Cl. 715/853; 715/513; 707/104.1

(57) ABSTRACT

A process for enabling a visitor to a website to make a criteria-based decision, which is accomplished by implementing a question and answer navigation tool that leads the visitor through a criteria search, teaching the visitor how to make a best informed decision based on their own criteria and unique buying patterns and unique situation. It thus provides a way for websites to address what and how buyers want to buy, rather than focusing on how the seller wants to sell the products.

### CROSS REFERENCE TO RELATED APPLICATION

This application is a continuation of application Ser. No. 09,909,411 filed Jul. 19, 2001; now abandoned.

### TECHNICAL FIELD

The present invention relates in general to information handling systems, and in particular, to navigation of websites over the Internet.

### BACKGROUND INFORMATION

The Internet has already significantly altered the way information is distributed and handled in the U.S. and the global economies. Navigation of the Internet and its millions of websites is already a big business in its own right, as evidenced by the success of Yahoo and other similar search engines. However, another important aspect of navigation is the decision-enablement of a particular website by a visitor. Many websites, especially those offering products, are often complicated, convoluted, and difficult to navigate as they have a great deal of information and do not offer a tool to enable visitors to discern their unique criteria for deciding what a “successful solution” would be. The problem with current methods for navigating websites is that they are currently being used much as sales has been used—to push and sell the product. That means there is an information base: “here is the product,” “here is what it does,” “here is why you should buy it,” “here is why working with us/buying from us would be a good thing,” etc. —all based on the seller making guesses on how, what or why the buyer might buy. Essentially, present day websites use search engines or general questions or menus in a manner so that the seller is pushing the information to the buyer. Such sites will continue to have the same problems and issues they have had for several years:
they will continue to attempt to guess what a client/visitor wants;
they will continue to push information, assuming that at least some of the information might be usable in the decision-making process, but without understanding what pieces, if any, are uniquely appropriate (and therefore making it all available to everyone just in case); and
they will continue to guess how each visitor wants to use the site, what they want out of it, how they want to use the site, and what criteria are used to make a decision, all based on group demographics as opposed to their unique criteria.

Therefore, there is a need in the art for an improved navigation tool, which meets the buyer's needs and would lead to a buyer learning how to decide how to make the best use of a site, navigate it according to their unique criteria, and have the site match the criteria in order to customize the response.

### SUMMARY OF THE INVENTION

The present invention addresses the foregoing need by working with buyer criteria rather than product information. This is accomplished by implementing a navigation tool that helps the customer delineate all peripheral criteria which would encompass a unique solution teaching the customer how to make a best informed decision based on their own criteria and unique buying patterns and unique situation, thus providing a way for sellers to address what and how buyers want to buy, rather than focusing on how the seller wants to sell the products.

Instead of the seller pushing information, the present invention provides a navigation tool leads a buyer through their own analysis in order to systematize their criteria. More specifically, the navigation tool of the present invention works with the buyer, not the product, to help with buying decisions. More specifically, the present invention works with how buyers decide (1) if a particular site is the one they would make a purchase or choice from; (2) how they would need to work with the site (leading to an iterative tracking process based on the buyer's buying patterns in contrast to the seller's selling patterns); and (3) what are the buyer's criteria that go into making their best decision based on all of their values, beliefs, buying patterns, rules, roles, issues, history, culture, and general (and unique) knowledge of their specific environment.

The foregoing has outlined rather broadly the features and technical advantages of the present invention in order that the detailed description of the invention that follows may be better understood. Additional features and advantages of the invention will be described hereinafter which form the subject of the claims of the invention.

In addition, the present invention provides a method of assisting sales individuals to automatically formulate questions and assist individuals with decision making based upon the above list of how buyers decide.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1-5 illustrate exemplary web pages for assisting a visitor in navigating a website in accordance with the present invention;

FIG. 6 illustrates a flow diagram in accordance with the present invention; and

FIG. 7 illustrates a data processing system configured in accordance with the present invention.

### DETAILED DESCRIPTION

In the following description, numerous specific details are set forth such as specific question and answer dialogs, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

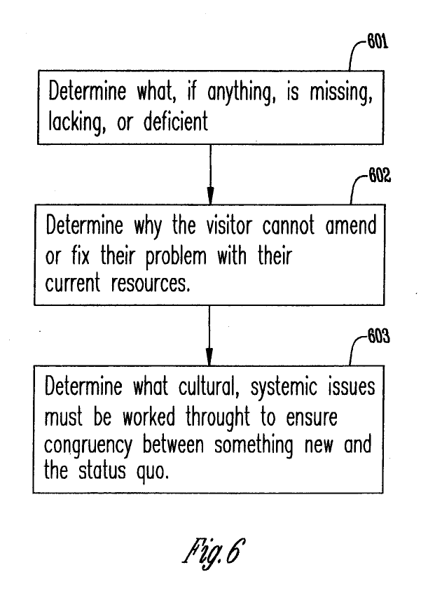

For a person to decide to do something different than what they currently are doing, such person needs to recognize that something is missing, in other words that there is a need and then, all of the parameters of the need. Then, generally such a person will try to fix the problem themselves, instead of looking externally. This is because people typically do not like change, and will desire to meet the need with what they already have. Therefore, such a person will not do something different if the solution is in hand. However, if they do not possess the solution to “fix” the need themselves, then the external (different) solution will still have to meet the person's criteria, and that person will compare the “new fix” against their cultural norms. If the new fix aligns with their cultural norms, then they will accept or buy the new external fix. The present invention implements a self-guided navigation tool for visitors to use on the front end of websites. It actually teaches site visitors how to navigate their unique, internal decision-making systems in order to uncover the criteria, needs, values, beliefs, that will enable them to use the site effectively. The navigation tool of the present invention is a decision-navigation enabling tool, which employs a unique form of question and response (Q/R) methodology. The principles used to design the Q/R methodology are based on criteria. They follow the path the human brain already uses to sort information in order to make decisions. The path taken is specific and goes in a linear direction, addressing the topics described hereinafter with respect to FIG. 6. In step 601, the first question the path takes is to determine what, if anything, is missing, lacking, or deficient. If someone decides to make a decision, they need to make sure that the decision will make a difference. The person needs all the specifics of what is not working before they will know what is working. Some critical questions might be:
What is preventing a visitor from having all their needs met with their current resources?˜
What would the visitor be willing to do differently to have a better chance to achieve their desired outcome?
How would they know that this site would help?
What would they need to see on this site to get the outcome they are seeking?

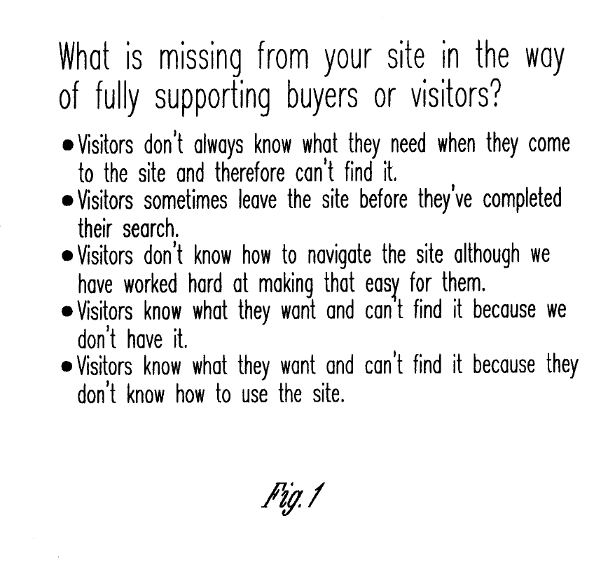

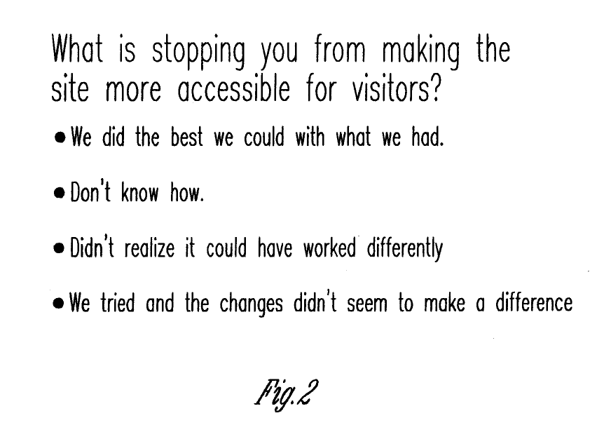

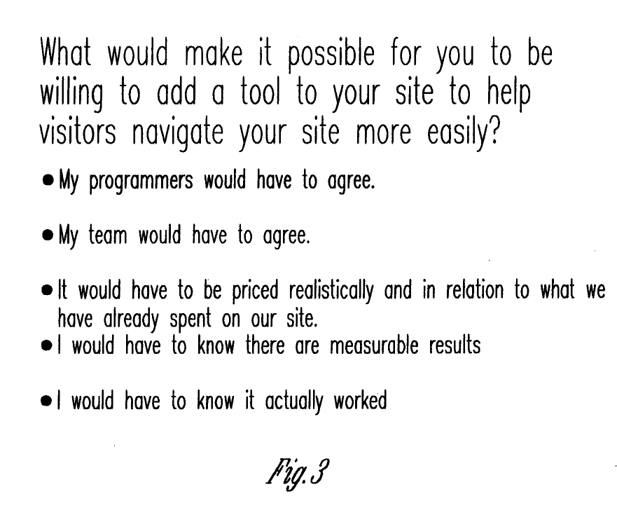

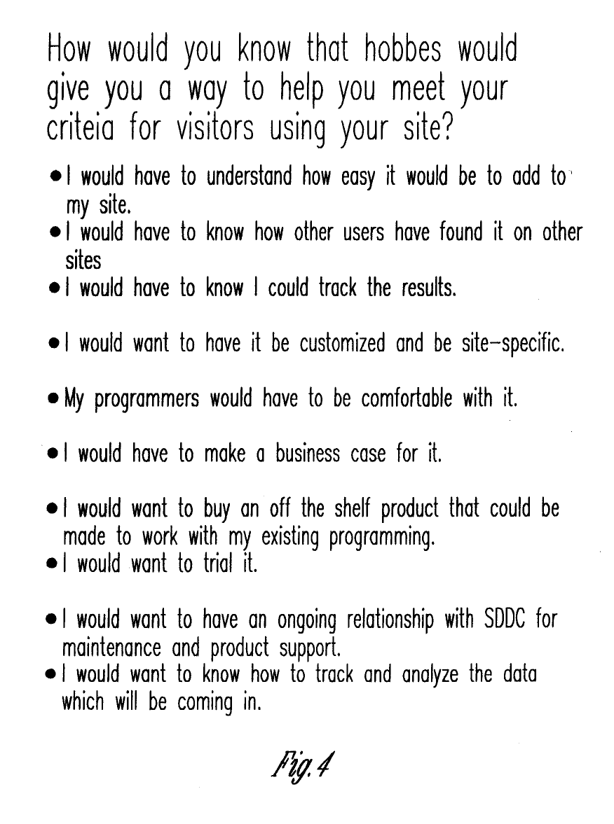

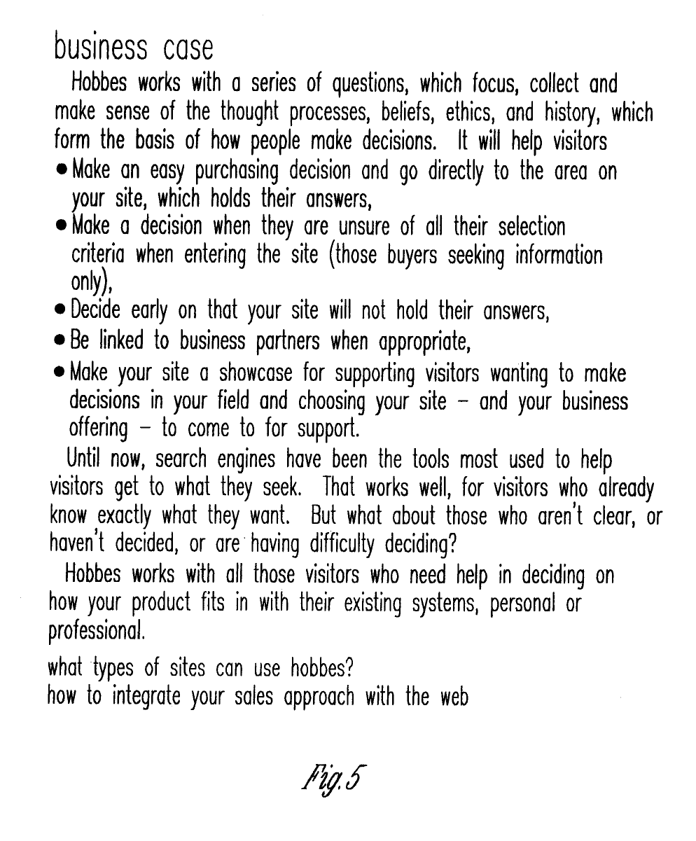

FIGS. 1-5 as hereinafter described provide an example of the question and response methodology of the present invention (see FIG. 6), the types of responses, and how the questions interact with the visitor in terms of how the visitor needs to make a decision. Each of FIGS. 1-4 provides a question directed at the person navigating the website using the process illustrated in FIG. 6. Each question will have a set of answers that the visitor can select. When a visitor selects one of the answers, it will then be shown another question and so on, resulting in the combination of questions and responses forming a decision tree. FIGS. 1-4 illustrate one path a visitor can take within this decision tree; the other paths are not shown for reasons of clarity, although there may be many trees on each front-end tool. In this example, what is described is the visitor selecting the first response in FIG. 1, which results in question #2 in FIG. 2 being shown to the visitor. The visitor then selects again the first response shown in FIG. 2 which directs the visitor to question #3 in FIG. 3. Again, what is illustrated is an example of the visitor selecting the first response in FIG. 3, which causes question #4 to be shown to the visitor. The example then describes the visitor selecting the sixth response in FIG. 4, which results in the answer being shown to the visitor in FIG. 5.

Referring to FIG. 1, there is illustrated an exemplary web page from a web site implementing the methodology of the present invention. FIG. 1 asks the question “what is missing from your site in the way of fully supporting buyers or visitors?” In this question, the Q/R methodology is asking the site visitor to begin to decide what is missing (see step 601). Before someone will decide to do something different, they need to fully understand why a change would be necessary, i.e., the need to fully scout out all of the possible issues involved with what might be deficient or missing with what they have currently. If what they have works, they do not need something new. Thus, a first goal with the Q/R methodology of the present invention is to get the visitor to understand, recognize, identify and distinguish what is missing and how it got that way. The five responses in the example illustrated in FIG. 1 originate from actual research on companies who complain that their web sites are inadequate. When creating more generic Q/R trees, the present invention will research all possible reasons why something is less than it is in a given context. Note that none of the responses include blame or any type of pitch; all responses are neutral and do not annoy, push information, or ask for information. They are thus not product or information specific. Each of these responses leads to an individual question, which will lead them further down their own discovery process. The next set of questions, sequentially and systematically linear, will take the process to the next stage of getting the visitor to understand how “what's missing” got to be missing. People do not like change. Until or unless they understand fully that there is a problem, they will not do anything differently. If the web page tells them they are doing something “wrong”, they will become defensive. They must decide for themselves.

In the present example, the visitor has selected (e.g., mouse clicked on hyperlink) the first response: “visitors don't always know what they need when they come to the site and therefore can't find it.” This leads down a path (e.g., hyperlink) in the decision tree of the Q/R process to question #2 illustrated in FIG. 2. Note, if the visitor had selected one of the other responses in FIG. 1, a different path (e.g., hyperlink) would have been taken to different questions.

Referring to FIG. 2, there is illustrated question #2 of the exemplary Q/R methodology illustrated in FIGS. 1-5. Question #2 is still concerning itself with assisting the visitor in determining what is missing (see step 601). This question to the site visitor asks “what is stopping you from making the site more accessible for visitors?” This question is beginning to address the decision-navigation process of the visitor. At this point, the visitor must go into their own thought process and ask just what the problem is—is it a systems problem? a political problem? an ignorance problem? a frustration problem? In any given Q/R methodology session, the visitor must discover precisely how they decided—what criteria they used to end up where they are, in the situation they are in. They need to come to some decision (again, all questions are asking the visitor to make some sort of decision, and the decisions rest on each other and are sequential). Note that each page has an “out” so that the visitor can just use the menu if the visitor is too uncomfortable asking these questions. The responses again have no pitch, no product, no push. Just giving the visitor the ability to discover their own best answer leads to their own best solution and decision.

The path in the Q/R methodology process that is next taken is step 602 wherein it is determined why they cannot fix their problem. Until someone recognizes that what they have are known to be familiar or does not work as well as it could, they will not understand the need to make a different decision (e.g., buy a new car, use PRICEL1NE.COM instead of their travel agent). The Q/R methodology of the present invention will help their brains discover their criteria for using what they have or making a decision to do something different. Some critical questions in this path might be:
What is the visitor planning on walking away with from this site?
How would the visitor know they were successful in getting their needs met?
What is stopping the visitor from using what they already have and not doing anything different?
How would the visitor know it was time to do something different?

The example shows that in FIG. 2 the visitor has selected the first response to question #2: “We did the best we could with what we had.” In this exemplary decision tree, this response leads to question #3 illustrated in FIG. 3, which asks “What would make it possible for you to be willing to add a tool to your site to help visitors navigate your site more easily?” In this question, the operative words are “what would make it possible?” The question is asking the visitor to make a new decision if they are not happy with the one already made. The visitor is asked to recognize something new is needed, and to decide if they are willing to do something different. This is pivotal to the process. In fact, what is essentially being asked is what are the criteria the visitor will use to change. Here the visitor will give all of the external reasons why they have not changed (e.g., their team, results, etc.). The responses include tangible criteria for change, blameless decision-support, and a real opportunity for personal discovery on the part of the visitor.

Responses include the criteria for change: tangible things to change, thus informing the visitor that change is doable. What the responses do is lead the visitor through their resistances, fears and unwillingness to change. The responses inform the visitor that such change is doable, possible, and even necessary.

In the example illustrated in FIG. 3, the response selected by the visitor is “my programmers would have to agree.” This leads down the decision path to question #3 described below with respect to FIG. 4. FIG. 4 is an example of an implementation of step 603 illustrated in FIG. 6.

Step 603 of the Q/R methodology of the present invention asks what systemic issues must be worked through to ensure congruency between something new and the status quo (e.g. in the family, the wardrobe, the team, etc.)? Everything is part of a system. People adjust to the systems they are in, or create new ones. Systems are based on the values of those people who belong to them. In order for something new to become a part of a current system, the “new thing” must adhere to the values into which it will be operating. In other words, if someone wears only natural fibers, they will not buy a nylon item. Or, if a company invests heavily in “green” investments, they will not invest in a tobacco company. No matter what product or services being sold, if the person does not know how it will fit into the existing system and the values of that system, they will not know how to buy on that site. Some critical questions might be:
How would the visitor know that the information/items/services they are seeking from the site would fit into their current environment?
What would the visitor need to see on the site to know if the site's products would work for the visitor?
What would the visitor need to see from the seller to know if the visitor would trust the seller to make a purchase from?

Question #4 illustrated in FIG. 4 asks “How would you know that the present invention would give you a way to help you meet your criteria for visitors using your site?” Question #4 is wrapping up the Q/R process down this path in the decision tree. What the visitor has realized is that they are willing to change and that they cannot do it themselves. But at this point, the visitor has not yet discovered how they will choose one solution over another. At some point, the visitor will have to understand precisely what is necessary to make a change. Question #4 is asking how they would know that a certain solution is the answer. This is where the website will provide the answer.

Many sites offer so much information that visitors are confused from the moment they enter the site. They essentially do not know what to do with such voluminous information. This is evidenced by thousands of examples in thousands of websites where visitors have clicked many times but sales are far and few between. Such visitors that did not buy left not because they did not need the product, not because they did not understand all of the information, they left because they did not know what to do with the information the site offered. The present invention offers a way to help the visitor understand exactly what to do with the site (what they need from the site), how to decide what changes to make, and what information they want specific to their needs and their criteria for choosing in their own unique set of standards and culture—not specific to what the site is selling. Thus, the present invention is criteria-and-decision-specific, not information-and-product-specific.

The responses provided to question. #4 provide all the ways people decide: with more information that is specific to the visitors culture, with buy-in from others, with follow-up support (to encourage trust); and with left-brained analysis needs. Each system a person or visitor or team is unique, yet they all fall into unique quantifiable patterns of choice. They want to know if they can trust the supplier, if they have buy-in from their peers, if they can make sense of it, and if they can be made to “rest easy” with their decision. The job of the Q/R methodology of the present invention is to respond to all of the above. In each website, the present invention will present all questions and responses to lead to the criteria people use to make a decision which will make them comfortable and which will fulfill their values and criteria in their unique environment. If it does not fit, the product pitch would not work no matter how wonderful is the information that is offered.

In the example illustrated in the Figures, the visitor has selected the sixth response (e.g., hyperlink): “I would have to make a business case for it.” Actually, any of the responses might have been the answer. Each site can be customized for each visitor in a unique way, and the visitor only has to read or get information about exactly that solution which meets the visitor's criteria for a unique solution. After selecting the sixth response, the example illustrated in FIGS. 1-5 finally leads the visitor to the answer illustrated in FIG. 5.

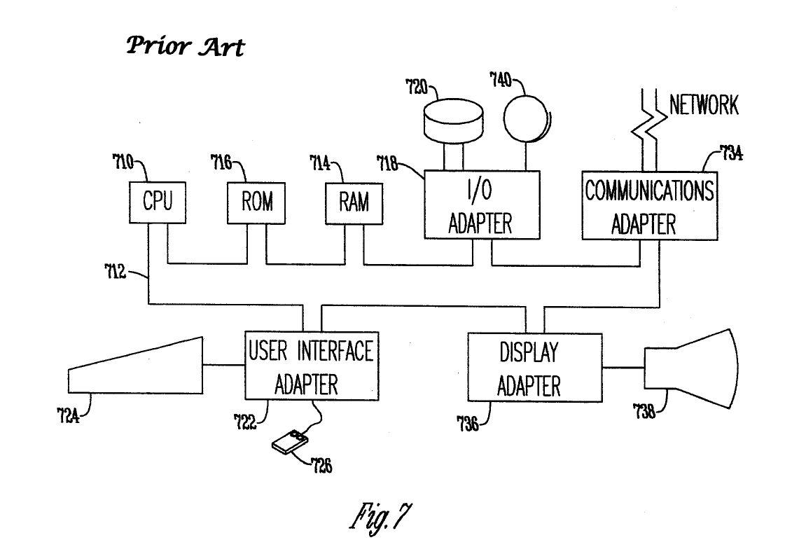

Referring to FIG. 7, an example is shown of a data processing system 700 which may be used for the invention, such as the server implementing the website and the client machine accessing the website. The system has a central processing unit (CPU) 710, which is coupled to various other components by system bus 712. Read only memory (“ROM”) 716 is coupled to the system bus 712 and includes a basic input/output system (“BIOS”) that controls certain basic functions of the data processing system 700. Random access memory (“RAM”) 714, I/O adapter 718, and communications adapter 734 are also coupled to the system bus 712. 110 adapter 718 may be a small computer system interface (“SCSI”) adapter that communicates with a disk storage device 720. Communications adapter 734 interconnects bus 712 with an outside network such as the Internet enabling the data processing system to communicate with other such systems. Input/Output devices are also connected to system bus 712 via user interface adapter 722 and display adapter 736. Keyboard 724, track ball 732, mouse 726 and speaker 728 are all interconnected to bus 712 via user interface adapter 722. Display monitor 738 is connected to system bus 712 by display adapter 736. In this manner, a user is capable of inputting to the system throughout the keyboard 724, trackball 732 or mouse 726 and receiving output from the system via speaker 728 and display 738.

Preferred implementations of the invention include implementations as a computer system programmed to execute the method or methods described herein, and as a computer program product. According to the computer system implementation, sets of instructions for executing the method or methods are resident in the random access memory 714 of one or more computer systems configured generally as described above. Until required by the computer system, the set of instructions may be stored as a computer program product in another computer memory, for example, in disk drive 720 (which may include a removable memory such as an optical disk or floppy disk for eventual use in the disk drive 720). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

What is important is that the present invention is not a search engine that finds the right product given product parameters such as size, color, etc. It is instead a decision-navigation enabling tool that uses the net as it was meant to be used: to support unique decisions in an interactive way.

Although the present invention and its advantages have been described in detail, it should be understood that various changes, substitutions and alterations can be made herein without departing from the spirit and scope of the invention as defined by the appended claims.

What is claimed is:

1. A process for enabling a visitor to make a criteria-based decision when browsing a website, comprising the steps of:
presenting a first set of one or more questions to the visitor on a webpage at the website, wherein the first set of one or more questions assist the visitor in determining what is missing with respect to a problem the visitor is seeking to solve;
presenting a second set of one or more questions to the visitor on a webpage at the website, wherein the second set of one or more questions assist the visitor in determining why the visitor is unable to adequately solve the problem with resources currently at the visitor's disposal;
presenting a third set of one or more questions to the visitor on a webpage at the website, wherein the third set of one or more questions assist the visitor in determining whether an identified solution to the problem is acceptable to the visitor when compared to the visitor's criteria.

2. The process as recited in claim 1, wherein the visitor's criteria include cultural norms held by the visitor.

3. The process as recited in claim 1, wherein the second set of one or more questions is presented to the visitor in response to the visitor selecting a response to the first set of one or more questions, and wherein the third set of one or more questions is presented to the visitor in response to the visitor selecting a response to the second set of one or more questions.

4. The process as recited in claim 3, further comprising the step of: presenting further details on the identified solution to the visitor on a webpage at the website in response to the visitor selecting the identified solution.

5. The process as recited in claim 1, wherein the first set of one or more questions consists of the group of questions: What is preventing a visitor from having all their needs met with their current resources?; What would the visitor be willing to do differently to have a better chance to achieve their desired outcome?; How would they know what this site would help?; and What would they need to see on this site to get the outcome they are seeking?.

6. The process as recited in claim 5, wherein the second set of one or more questions that determine why the visitor is unable to adequately solve the problem consists of the group of questions: What is the visitor planning on walking away with on this website?; How would the visitor know they are successful in getting their needs met?; What is stopping the visitor from using what they already have and in not doing anything different?; and How would the visitor know it was time to do something different?.

7. The process as recited in claim 6, wherein the third set of one or more questions that assist the visitor in determining whether an identified solution to the problem is acceptable consists of the questions in the group: How would the visitor know that the information/items/surfaces they are seeking from the cite would fit into their current environment?; What would the visitor need to see on the cite to know if the website's products would work for the visitor?; What would the visitor need to see from the seller if the visitor would trust the seller to make a purchase from?.

8. A method of enabling a visitor to make a criteria-based decision when browsing a website, comprising the steps of:
acquiring research on why websites are inadequate;
formulating a first question presented to the visitor on the website in a form that assists the visitor to identify what element is missing from the website;
automatically providing a first set of responses to the first question based on the research from which the visitor selects;
formulating a second question based on the selected first response in a form that assists the visitor to determine why the element is missing from the website;
automatically providing a second set of responses to the second question based on the research from which the visitor selects;
formulating a third question based on the selected second response in a form that assists the visitor to determine whether a solution to the missing element meets the visitor's criteria;
automatically providing a third set of responses to the third question based on the research from which the visitor selects; and
providing a solution based on the research and the visitor's selected third response.
